(19) United States
(12) Patent Application Publication
(10) Pub. No.: US 2014/0115491 A1
(43) Pub. Date: Apr. 24, 2014

(54) PORTABLE ELECTRONIC DEVICE HAVING A USER INTERFACE FEATURES WHICH ARE ADJUSTABLE BASED ON USER BEHAVIOUR PATTERNS

(71) Applicants: Peter Cullin, Staffanstorp (SE); Calle Krokstade, Sha Tin Hong Kong (CN)

(72) Inventors: Peter Cullin, Staffanstorp (SE); Calle Krokstade, Sha Tin Hong Kong (CN)

(73) Assignee: DORO AB, Lund (SE)

(21) Appl. No.: 14/111,941

(22) PCT Filed: Apr. 13, 2012
(86) PCT No.: PCT/EP12/56765

§ 371 Date: Jan. 6, 2014

Related U.S. Application Data
(60) Provisional application No. 61/479,628, filed on Apr. 27, 2011.

(30) Foreign Application Priority Data
Apr. 15, 2011 (EP) 11162706.3

(51) Int. Cl. G06F 3/0481

(52) U.S. Cl. CPC G06F 3/0481
USPC 715/745

(57) ABSTRACT

A portable electronic device is presented which has a display and control means for setting of a user interface feature, and user behavior monitoring means. The user behavior monitoring means is configured to watch for a predefined user behavior pattern and, upon detection of said user behavior pattern, cause said control means to set a corresponding user interface feature.

### TECHNICAL FIELD

The present invention generally relates to the field of portable electronic equipment, and more particularly to a portable electronic device having configurable user interface features.

The present invention also relate to a portable electronic device of the type that has a keypad with a plurality of keys, at least some of which have multiple functions, specifically such that when a time lapse between two successive actuations of one and the same particular key is shorter than a threshold delay time, a first action is taken on the display, whereas otherwise a second action is taken on the display.

### BACKGROUND

Portable electronic equipment comes in many different brands, shapes and types. One very common example is a mobile terminal, such as a mobile telephone for a mobile telecommunications system like GSM, UMTS, D-AMPS, CDMA2000, FOMA or TD-SCDMA. Other examples include personal digital assistants (PDA:s), portable media players (e.g. MP3 players), palmtop computers, digital cameras, game consoles, navigators, etc. A mobile terminal in the form of a mobile telephone will be used as a non-limiting example of a portable electronic device in the following.

In the early days of mobile telecommunications, the mobile terminals were used for speech communication only. The situation has of course changed dramatically since then. Nowadays, mobile terminals are also frequently used for professional, personal and recreational services and thus contain a plurality of application programs such as calendar, messaging, word processing, www browsing, etc. For many if not all of these additional services, there is a need for the user to input text on the mobile terminal.

The prevailing way of inputting text on a mobile terminal is to use a keypad on the terminal. Conventionally, mobile terminals have been provided with a physical (mechanical) keypad with twelve keys representing digits “0” through “9” as well as signs “*” and “#”. This kind of keypad, which is commonly known as an ITU-T or a PIN-type keypad, provides the user with all the symbols needed for dialing a telephone number and thus represents a complete symbol set for this type of operation. On the other hand, when text or other kind of data than numbers is to be input, the twelve keys are typically not many enough to represent one possible symbol each. In such a case, an individual key may be assigned multiple functions, such that it may represent more than one possible symbol input. For instance, the “2” key may represent a set of available characters “A”, “B” and “C”, in addition to or instead of the number “2”. Correspondingly, the “3” key may represent another set of available characters “D”, “E” and “F”, in addition to or instead of the number “3”, and so on.

By repeatedly actuating for instance the “2” key, the user may cycle through this set of available symbols as presented at the current cursor position on the display. When the desired symbol, such as “C”, is shown on the display, the user may either actuate another key on the keypad, or wait a certain time without any further actuation of any of the keys. In both cases, the shown desired symbol will be accepted by the text entry functionality of the mobile terminal, and the cursor will be advanced one step on the display. This mode of data entry is referred to as multi-tap text entry, or simply multi-tap entry, in the remainder of this document, and a keypad capable of such data entry is referred to as a multi-tap keypad.

In multi-tap entry, the time period that must lapse before the currently shown symbol is accepted and the cursor is advanced, is referred to as a threshold delay time or, synonymously, multi-tap timeout period. Phrased differently, when the threshold delay time has lapsed without any intermediate key actuation, a timeout occurs, and the cursor is advanced. On the other hand, if one and the same key is repeatedly actuated more frequently than what the threshold delay time defines, and without intermediate actuation of another key on the keypad, the set of available symbols for the actuated key will be cycled through from the first symbol throughout the last symbol, and then again starting from the first symbol.

In recent years, mobile terminals, also known as smart phones, with touch-sensitive display screens have become increasingly popular. Even though a smart phone does not need a physical keypad thanks to the inherent ability of the touch screen to act also as input device, the concept of multi-tap entry is used in many smart phones. For instance, the Sony Ericsson Xperia X10 Mini series run an Android operating system where a virtual keypad is presented on the touch-sensitive display screen when various different text input fields are tapped. The virtual keypad has a 3×3 grid layout where each element represents a list of available symbols, which may be cycled through sequentially by way of multi-tapping on the respective element.

Therefore, the term multi-tap keypad as used in this document is not limited to physical keypads with mechanical keys.

As already referred to above, a modern mobile terminal is normally provided with a large variety of application programs, most of which need text entry in order to work as intended. Because of its inherent operational principle which is based on a timeout after the lapse of the threshold delay time, it is important to provide text entry in a manner which is efficient to the user and minimizes input errors caused by incorrect symbols entries. This is particularly so when large amounts of data are to be entered, for instance as part of a text message or calendar record, or during the course of filling in a web form in the www browser.

The present inventors have identified some drawbacks with existing multi-tap entry devices. One such identified drawback is that the duration of the threshold delay time is fixed and set by the designers of the terminal hardware or operating system. Whereas these designers may have some freedom is deciding the duration of the threshold delay time (constrained by the performance restrictions of the hardware and operating system), once the design has been completed, the threshold delay time is a fixed property in the mobile terminal.

Moreover, the present inventors have realized that users of mobile terminals are nowadays a very heterogeneous group in which there are considerable variations in terms of age, user experience, physiological motor ability, visual capacity, and general user preference. Existing multi-tap entry devices fail to fully appreciate this.

The same problems exist for other user interface features, and users of different experience levels suffer or are restricted in their operation of a device to different degrees.

### SUMMARY

It is accordingly an object of the invention to eliminate or alleviate at least some of the problems referred to above, by realizing that users of different experience levels benefit from different user interface features.

One aspect of the present invention is a portable electronic device comprising a display and control means for setting of a user interface feature, and user behavior monitoring means configured to watch for a predefined user behavior pattern and, upon detection of said user behavior pattern, cause said control means to set a corresponding user interface feature.

A portable electronic device having a user-configurable user interface feature wherein the user interface feature is adjusted based on a monitored user behavior is thereby provided.

The inventors have realized that by monitoring user behavior patterns, in contrast to focusing on user capabilities (such as input speed using a keypad), a better understanding of the user is achieved which allows for an adjustment of the user interface according to an individual user's more general needs and preferences. This makes the portable device more attractive to use. This also allows for a faster adjustment of a device to a user's needs and preferences as the capabilities do not need to be determined, whereas, for example, the downloading of a particular program is an action that only takes a short time to achieve while it may tell a lot about the user.

One example of a user interface feature is the threshold delay time for multi-tap entry. Other examples of user interface features are a display resolution, a size of a touch area for a virtual key, a font size of text that is displayed on the display and whether confirmation dialogues should be used for a specific application or group of applications.

Another aspect of the present invention is a portable electronic device comprising a display and a keypad having a plurality of keys, at least some of which have multiple functions, specifically such that when a time lapse between two successive actuations of one and the same particular key is shorter than a threshold delay time, a first action is taken on said display, whereas otherwise a second action is taken on said display, wherein the portable electronic device is provided with control means for user-configurable setting of said threshold delay time.

A portable electronic device having a user-configurable multi-function key entry timeout is therefore provided.

Embodiments of the invention are defined by the appended dependent claims and are further explained in the detailed description section.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Objects, features and advantages of embodiments of the invention will appear from the following detailed description, reference being made to the accompanying drawings, in which:

FIG. 1 is a schematic illustration of a non-limiting example of a telecommunication system in which embodiments of the present invention may be exercised;

FIG. 2a is a schematic front view of a portable electronic device according to one embodiment of the present invention, in the form of a mobile terminal having a physical keypad with mechanical keys, capable of multi-tap entry;

FIG. 2b is a schematic front view of a portable electronic device according to another embodiment of the present invention, in the form of a mobile terminal of smart phone-type, having a touch-sensitive display screen with a virtual keypad presentable thereon, capable of multi-tap entry;

FIG. 3 is a schematic block diagram illustrating the basic internal hardware and software layout of the mobile terminal according to any of the embodiments shown in FIGS. 2a and 2b; and

FIG. 4 is a schematic block diagram illustrating some main elements of a portable electronic device enabled for user-configurable setting of the threshold delay time for multi-tap entry in accordance with embodiments of the invention.

### DETAILED DESCRIPTION

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

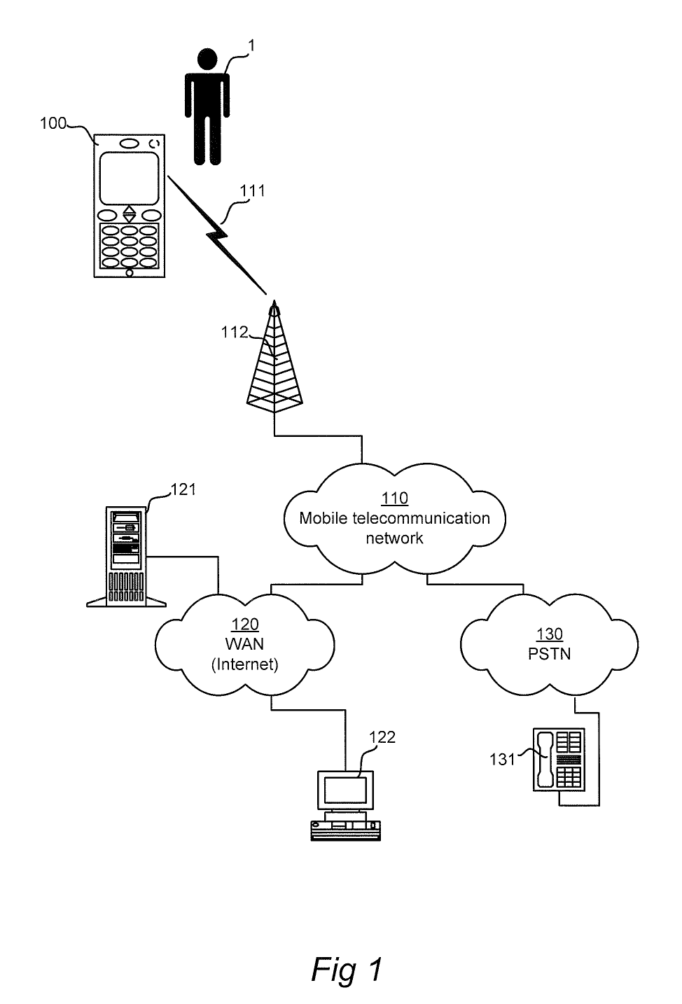

Before turning to a detailed description of the disclosed embodiments, an exemplifying environment in which they may be exercised will now be briefly described with reference to FIG. 1.

In FIG. 1, a portable electronic device in the form of a mobile terminal 100 is part of a cellular telecommunications system. A user 1 of the mobile terminal 100 may use different telecommunications services, such as voice calls, Internet browsing, video calls, data calls, facsimile transmissions, still image transmissions, video transmissions, electronic messaging, and e-commerce. The invention is however not limited to any particular set of services.

The mobile terminal 100 may connect to a mobile telecommunication network 110 over a radio link 111 and a base station 112. The mobile terminal 100 and the mobile telecommunication network 110 may comply with any commercially available mobile telecommunication standard, for instance (without limitation) GSM, UMTS, LTE, D-AMPS, CDMA2000, FOMA and TD-SCDMA. Embodiments of the mobile terminal 100 will be described in closer detail with reference to the following drawings.

A public switched telephone network (PSTN) 130 is connected to the mobile telecommunication network 110. Telephone terminals of PSTN subscribers may connect to the PSTN 130. In FIG. 1, a stationary telephone 131 is indicated as a mere example of this.

The mobile telecommunication network 110 is operatively associated with a wide area data network 120, which may be the Internet or a part thereof. Server computers 121 and client computers 122 may be connected to the wide area data network 120 to allow communication with the mobile terminal 100.

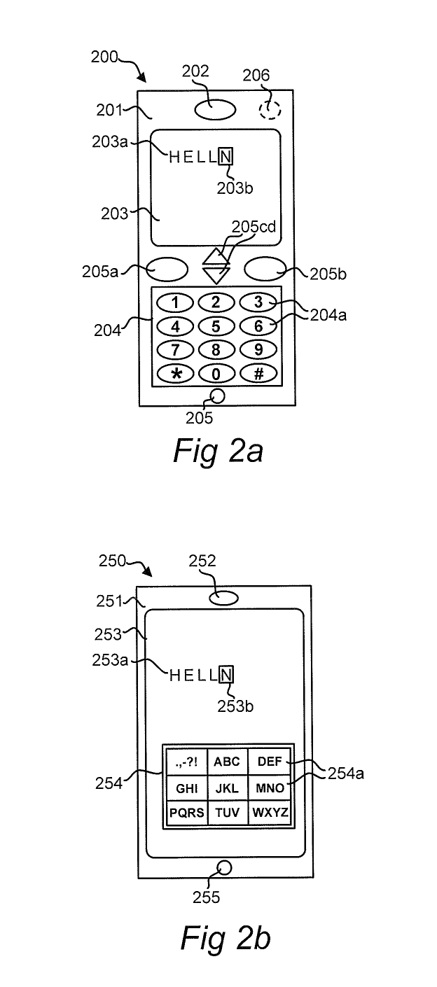

An embodiment 200 of the mobile terminal 100 is illustrated in more detail in FIG. 2a. The mobile terminal 200 is of monoblock-type and has a housing that includes a front side 201. The front side 201 has a user interface (UI) or man-machine interface (MMI) which involves a loudspeaker 202, a microphone 205, a display 203, and an ITU-T-type keypad 204. The keypad 204 is a physical (mechanical) keypad with twelve keys representing digits “0” through “9” as well as signs “*” and “#”. The keypad 204 is capable of multi-tap entry, for instance to input text 203a on the display 203. In the situation shown in FIG. 2a, the user 1 has entered four characters “H”, “E”, “L”, “L” and is about to complete the word “HELLO” by repeatedly actuating the “6” key to cycle through a set of available symbols “6, M, N, O” so as to arrive at the desired “O” character at the current cursor position 203b.

Certain other special keys are also provided, here illustrated as soft keys 205a-b and navigation keys 205c-d. Furthermore, a camera 206 is provided at a rear side of the terminal's housing, opposite the front side 201. Other well-known components may also be provided, such as power switch, battery, charger interface, accessory interface, volume controls and external antenna, but are not indicated in FIG. 2a in order not to obscure the disclosure in unnecessary detail.

Another embodiment 250 of the mobile terminal 100 is shown in FIG. 2b. The mobile terminal 200 of this embodiment is of smart phone-type and has a touch-sensitive display screen 253 provided at a front side 251 of the terminal housing. A virtual keypad 254 is presentable on the display screen 253. The virtual keypad 254 is capable of multi-tap entry and has a plurality of touchable elements 254a arranged in a grid layout. Just like the mechanical keys 204a of FIG. 2a, each touchable element 254a represents a list of available symbols, which may be cycled through sequentially by way of multi-tapping on the element in order to enter text 253a on the display screen 253, the current cursor position being indicated at 253b.

The front side 251 has a loudspeaker 252 and a microphone 255. Certain special keys, even mechanical ones, may be provided in addition to the touch-sensitive display screen 253, even though not shown in FIG. 2b. Also, other well-known components, such as camera, power switch, battery, charger interface, accessory interface, volume controls and external antenna, may be provided but are not indicated in FIG. 2b.

Other kinds of mobile terminals are also fully conceivable embodiments of a portable electronic device according to the present invention. Mobile terminals having two main housing parts hinged together to form a clamshell phone or a swivel phone are some examples that are worth mentioning.

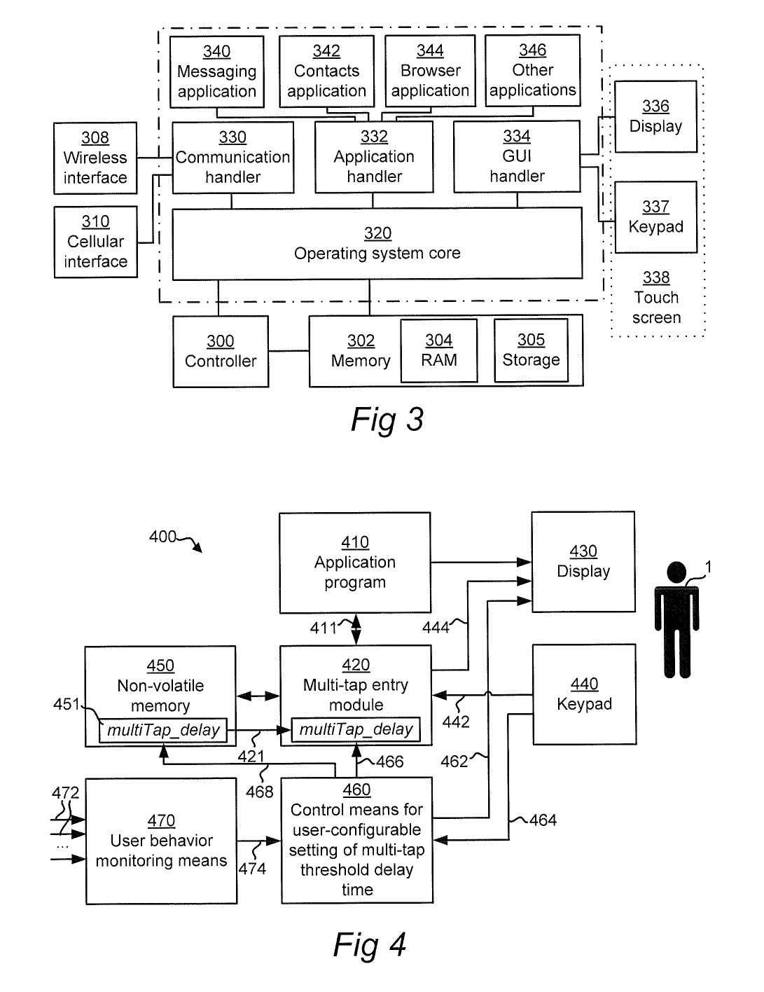

The internal software and hardware structure of the mobile terminal 200 or 250 according to any of the embodiments shown in FIGS. 2a and 2b will now be described with reference to FIG. 3. Software components are indicated within a dash-dotted frame, whereas hardware components are outside of this frame. The mobile terminal 200/250 has a controller 300 being responsible for general device operations. Any commercially available central processing unit (CPU) or digital signal processor (DSP), or other programmable electronic logic device such as an application-specific integrated circuit (ASIC) or field-programmable gate array (FPGA), may be used to implement the controller 300. The controller 300 has associated memory 302 which includes a work memory (RAM) 304 and a non-volatile storage memory 305, for instance in the form of EEPROM, flash memory (e.g. memory card), hard disk, or any combination thereof. The controller 300 uses the memory 302 for different purposes, for instance for storing file objects as well as data and program instructions for the software in the mobile terminal 200/250.

The software includes an operating system core 320 on a lower level, application programs 340-346 on an upper level for interaction with the user 1, and drivers and handlers for the hardware and the application programs on an intermediate level. The intermediate level includes a GUI handler 334 which forms a user interface towards the user 1 by controlling display 336 (203/253), keypad 337 (204/254) as well as other I/O devices which may be included in the mobile terminal 200/250 (e.g. microphone, loudspeaker, vibrator, ringtone generator, LED status indicator, audio volume controls, etc). When the display 336 comprises a touch-sensitive display screen 338, like display screen 253 in FIG. 2b, the GUI handler 334 controls this display screen 338 to act both as an output device and an input device.

An application handler 332 controls the application programs 340-346, which may include a messaging (e.g. SMS, MMS or email) application 340, a contacts application 342, a browser (e.g. www, wap) application 344, as well as various other applications 346, such as applications for voice calls, video calls, calendar, file handling, a control panel or settings application, a camera application, one or more video games, a word processing application, a spreadsheet application, a drawing application, a slideshow presentation application, etc.

The software also includes various modules, protocol stacks, drivers, etc., which are commonly designated as communication handler 330 and which provide communication support for a cellular interface 310 and, optionally, a wireless interface for Bluetooth, WLAN, NFC or IrDA (commonly designated as 308 in FIG. 3). The cellular interface 310 comprises an internal or external antenna as well as appropriate radio circuitry for establishing and maintaining a wireless link to a base station (e.g. the link 111 and base station 112 in FIG. 1). The radio circuitry comprises a radio transmitter and receiver (transceiver; TX/RX), formed for instance by band pass filters, amplifiers, mixers, local oscillators, low pass filters, AD/DA converters, etc.

With reference to FIG. 4, an arrangement 400 of some main elements of a portable electronic device, which is enabled for user-configurable setting of a user interface feature, such as the threshold delay time for multi-tap entry, in accordance with embodiments of the invention, will now be described. The description is made with exemplifying reference to the embodiment of FIG. 2a, where the portable electronic device is implemented as a mobile terminal 200; however, the skilled person readily realizes that the arrangement 400 could also be applied to other embodiments, including but not limited to the smart phone terminal 250 of FIG. 2b. The skilled person would also realize that the arrangement can also be applied to other user interface features than the delay time for multi-tap entry as in the example of FIG. 4.

As seen in FIG. 4, the arrangement 400 comprises a multi-tap entry module 420 which can be invoked whenever an application program 410 (such as one of the application programs 340-346 of FIG. 3) requires text input from the user 1. The multi-tap entry module 420 may be implemented in software and is advantageously a part of the GUI handler 334 of FIG. 3. The multi-tap entry module 420 is operatively connected to a display 430 and a keypad 440 (e.g. display 203 and keypad 204 of FIG. 2a) to detect actuation of any of the keys in the keypad 430, and in response present on the display 430 a first symbol in the available symbol set associated with the actuated key. See 442 and 444 in FIG. 4. The multi-tap entry module 420 then monitors the keypad 440 to decide whether or not the same key is actuated again within a time lapse which is shorter than a threshold delay time, i.e. whether or not a timeout occurs. The threshold delay time is represented by a variable multiTap_delay, the value of which may be configured by the user 1 as will be apparent from the following description. To this end, control means 460 for user-configurable setting of the threshold delay time is provided.

When the time lapse between two successive actuations of one and the same particular key in the keypad 440 is shorter than the threshold delay time multiTap_delay (i.e., no timeout), a first action is taken on the display 430, and otherwise (e.g., timeout) a second action is taken on the display. For the mobile terminal 200, the first action involves replacing, without cursor advancement, a currently presented character with a subsequent character on the display 203, wherein both characters are associated with that particular key since they both belong to the set of available symbols for that key. In the situation shown in FIG. 2a, the first action might comprise replacing the character “N” with the subsequent character “O” at the current cursor position 203b when the “6” key is again actuated within the threshold delay time. Conversely, the second action (i.e. after a timeout or an actuation of another key than the “6” key) might comprise keeping the currently presented character “N” on the display and advancing the cursor position 203b one step to the right. The text entry thus made is communicated (see 411 in FIG. 4) by the multi-tap entry module 420 to the application program 410 that requested it. This can be made character by character, or once the whole text entry is completed.

In one embodiment the control means 460 is configured to represent a user setting with a variable to make the user interface adaptable. The function and nature of the control means 460 for user-configurable setting of the threshold delay time will now be described in more detail. The control means 460 serves to make the user interface feature, such as the threshold delay time, adaptable to the individual needs and preferences of the user 1. To this end, the threshold delay time is represented by the aforementioned variable multiTap_delay; i.e. not a constant or a hardcoded value. The variable multiTap_delay is set to a default value if no user configuration has occurred. The default value may be read from a memory area 451 in a non-volatile memory 450 (e.g. storage memory 305 of FIG. 3), when the mobile terminal 200 is powered on or subjected to a system reset, and the variable multiTap_delay will be assigned to the read default value (see 421 in FIG. 4). Correspondingly, other variables may represent other user interface features, as will be described further below.

In one embodiment, the control means 460 is configured to offer on the display 430 a plurality of available setting values of the user interface feature, such as the threshold delay time (see 462 in FIG. 4). The default value may be one of these available setting values. For instance, the available setting values of the threshold delay time may be 50 ms, 100 ms and 150 ms, where 100 ms is the default value. Both the number of available setting values and their respective values can of course vary considerably depending on implementation. The user 1 may thus select one of these offered values by actuating a key on the keypad 430 (see 464 in FIG. 4), or another I/O device. The control means 460 will then accept the selected setting value, and set the user interface feature, in this example being the threshold delay time multiTap_delay, to the selected setting value, see 466 in FIG. 4.

Advantageously, the control means 460 is further configured to store the selected setting value in the memory area 451 of the non-volatile memory 450, see 468 in FIG. 4. Thus, the next time the mobile terminal 200 is powered on or subjected to a system reset, the stored selected setting value will be read at 421 in FIG. 4 from the non-volatile memory 450, and the variable multiTap_delay for the threshold delay time will be set to the read selected setting value rather than the default value.

The threshold delay time (multiTap_delay) is one example of a user interface feature that the control means 460 is configured to adjust in accordance with the teachings herein.

Other examples of user interface features are a display resolution, a size of a touch area for a virtual key, a font size of text that is displayed on the display, and whether confirmation dialogues should be used for a specific application or group of applications.

In some embodiments, user behavior monitoring means 470 is provided to further enhance the user configurability of a user interface feature, such as the threshold delay time. The user behavior monitoring means 470 is configured to watch for a predefined user behavior pattern and, upon detection of this user behavior pattern, alert the control means 460 of this fact (see 474 in FIG. 4).

The user behavior pattern is associated with a corresponding user interface feature. This association can be a one to many relationship, a many to many and also a many to one relationship, so that one or more user behavior patterns are associated with one or more corresponding user interface features. One example will be described below for a user interface feature in the form of the threshold delay time.

When the user behavior monitoring means 470 has detected the user behavior pattern, it will cause the control means 460 to present on the display 430 an offer to change a user interface feature, such as the threshold delay time, to a value reflecting the detected user behavior pattern. After having accepted a confirmation from the user 1 by way of the keypad 440 or another I/O device, the control means 460 will set the user interface feature, such as the threshold delay time multiTap_delay, to the offered and accepted value, see 466 in FIG. 4.

Advantageously, the control means 460 is further configured to store the offered and accepted value for an adjusted user interface feature, such as the threshold delay time, in the non-volatile memory, in the memory area 451 of the non-volatile memory 450, see 468 in FIG. 4. Again, the next time the mobile terminal 200 is powered on or subjected to a system reset, the stored value may be read at 421 in FIG. 4 from the non-volatile memory 450, whereupon the variable multiTap_delay for the threshold delay time will be set to the read value rather than the default value.

In the example described above, the user interface feature of the threshold delay time is associated with a user behavior pattern. Below, more examples of how the user behavior pattern is monitored, and what types of user behavior patterns there are, will be given.

In order to watch for the predefined user behavior pattern, the user behavior monitoring means 470 may use input signals 472 from various components of the mobile terminal 200. In one embodiment, the predefined user behavior pattern involves when the user 1 has been found to use of one or more other services than pure voice calls. Such other services may for instance involve the use of the camera 206 for picture taking or MMS messaging, the keypad 203 for input of extensive text volumes (in contrast to the mere dialing of telephone numbers for voice calls), the display for presentation of other data than voice call related data, such as www browser or video game data, the loudspeaker 202 for other audio than voices (e.g. music tunes or game sound effects), or the memory 302 for storing file objects.

In one embodiment, the predefined user behavior pattern involves when the user 1 has been found to use or execute a plurality of applications simultaneously. In one embodiment the user interface feature is adjusted according to the number of applications that are executed simultaneously or in parallel. The more applications that are executed simultaneously, the more experienced the user is.

The rationale behind this is that when the user 1 has been found to use services like these or in such a manner, that kind of user behavior pattern is an indication that the user 1 is probably an experienced user and should therefore benefit from being offered an adjusted user interface feature, such as a shorter threshold delay time than default. Thus, the user behavior monitoring means 470 may conclude that the predefined user behavior pattern has been detected and alert the control means 460 accordingly, such that it will offer the user 1 the adjusted user interface feature, such as a shorter threshold delay time. The predefined user behavior pattern may contain qualifiers or lower limits as to the frequency or duration of use of the service in question, or be confined to only certain specific services.

In one embodiment, the predefined user behavior pattern involves that the user has made one or more changes among the various user-configurable settings in the graphical user interface of the mobile terminal 200. Such changes may pertain to UI themes, desktop images, ringtones, messaging settings (e.g. delivery or announcement parameters), etc. Again, such user behavior is an indication to the user behavior monitoring means 470 that the user 1 is probably an experienced user and should therefore be offered an adjusted user interface feature, such as a shorter threshold delay time than default, by the control means 460. In this example the behavior pattern is to adjust the graphical user interface of the mobile terminal 200, and the corresponding user interface feature to be adjusted is the threshold delay time. It should be understood that other user interface features such as the display resolution, and others disclosed herein, can also or alternatively be adjusted.

In one embodiment, the predefined user behavior pattern involves downloading, installation or execution of a particular application program or type of application program among the application programs 340-346. For instance, when a video game, media player or instant messaging application is downloaded, installed or executed, it may be assessed that this is probably because the user is experienced and should therefore benefit from being offered an adjusted user interface feature, such as a shorter threshold delay time than default. Conversely, when for instance a medication reminder application, elderly care application or visual aid application is downloaded, installed or executed, it may be assessed that the user might benefit from being offered an adjusted user interface feature, such as a longer threshold delay time than default. In this example the user behavior pattern involves downloading, installation or execution of a particular application program or type of application program, and the corresponding user interface feature to be adjusted is the threshold delay time. It should be understood that other user interface features such as the display resolution, and others disclosed herein, can also or alternatively be adjusted.

In one embodiment, the predefined user behavior pattern involves the frequency of use for a specific application or service. If a particular application or service that is associated with experienced users is used frequently the user shows indications of being an experienced user and may as such benefit from an adjusted user interface feature.

In one embodiment, the predefined user behavior pattern involves inputting commands. Such commands may relate to commands for a specific application or operating system specific commands for example for switching applications. In one embodiment the predefined user behavior pattern involves inputting particular commands, such commands being associated with an experienced user, for example formatting commands. If it is determined that a user inputs many commands frequently, that is indicative of that the user 1 is an experienced user and may benefit from adjusted user interface features. Analogously, if it is determined that a user does not input many commands, and that the commands are input at a slow pace and infrequently, this is indicative of an inexperienced user that also may benefit from an adjusted user interface feature. In this example the user behavior pattern is to input commands frequently, and the corresponding user interface feature to be adjusted is the threshold delay time. It should be understood that other user interface features such as the display resolution, and others disclosed herein, can also or alternatively be adjusted.

In one embodiment the control means 460 is configured to display a prompt on the display, after a time period has passed since a user interface feature was adjusted, prompting for acceptance of the adjusted user interface feature. This provides a user with an opportunity to accept or reject an adjusted setting. The control means 460 is configured to receive an acceptance from the user and determine whether the acceptance is positive or negative (a rejection of the adjusted setting). Should the acceptance be negative, the control means 460 is configured to reset the user interface feature to the setting it had before.

In one such embodiment the control means 460 is configured to display a notification on the display informing the user that the user interface feature has been adjusted as the user interface feature is adjusted.

In one embodiment the control means 460 is configured to display a prompt on the display prompting a user whether the adjusted user interface feature should be further adjusted. In one such embodiment the prompt comprises a list of selectable values. In one alternative such embodiment the prompt comprises an indication whether the user interface feature should be further increased or decreased. The control means 460 is configured to receive an indication from the user on how to further adjust the user interface feature.

The embodiments disclosed with reference to FIG. 4 are based on the user interface feature being the threshold delay time for the multi-tap entry. However, the same or similar arrangements are also applicable to other user interface features. Examples of such user interface features will be given below.

In one embodiment the user interface feature relates to the resolution to be used for the display. Experienced users are often interested in being able to show much content at once on a display, and adjusting the user interface feature so that the display resolution is increased allows an experienced user to do this. On the other hand, inexperienced users may be confused by too much information or have difficulty seeing a high resolution. Such users may benefit from having a lower resolution thereby presenting less content and at a larger size, allowing the user to focus on a task at hand.

Similarly, the user interface feature may relate to a font size of text that is displayed on the display. By using a larger font the text is more visible, and an inexperienced user may be allowed to focus more easily on the text being presented. By using a smaller font more text may be displayed, and an experienced user may be allowed to view more content without having to scroll the text being presented.

In one embodiment the display is a touch display and the control means 460 is configured to present a virtual keypad on the display. The virtual keypad has at least one virtual key. As is known, a virtual key has an associated touch area, and a touch that is detected in the touch area is determined to cause an actuation of the virtual key. The touch area may coincide with the perimeter or extent of the virtual key or it may be larger to simplify hitting the virtual key. In such an embodiment the user interface feature is related to the size of the touch area, and the control means 460 is configured to adjust the size of the touch area according to the monitored behavior of the user. The size of the virtual key may also be adjusted along with the adjustment of the associated touch area. By providing a larger touch area (or size of virtual key) an inexperienced user may be able to hit a wanted virtual key more accurately. By providing a smaller touch area (or size of virtual key) an experienced user may be provided with more keys offering a wider functionality for the portable device, as the keys can be grouped closer together.

As is known, some applications, and certain actions in such applications, are associated with the prompting of a notification or a confirmation dialogue box. Such boxes are highly useful to inexperienced users, whereas experienced users are sometimes slowed down or distracted by such dialogue boxes.

In one embodiment a user interface feature relates to whether such dialogue boxes should be displayed or not for a specific action or a specific application. In such an embodiment the control means 460 is configured to, based on a detected user behavior pattern, set the user interface feature relating to the prompting of dialogue boxes for a specific action or an application. An example of such a dialogue box is the confirmation box that a file is to be moved to a temporary delete folder, such as a trash can. An experienced user knows that the file can easily be retrieved at a later time, and as such the prompt is not as crucial as it is to an inexperienced user who may not be aware of how to retrieve a deleted file.

The control means 460 may be implemented in hardware, or alternatively as software in the portable electronic device (in the latter case, for instance as a part of the GUI handler 334, operating system core 320, or even one of the application programs 340-346), or as a combination thereof. The same goes for the user behavior monitoring means 470. In some embodiments, the control means 460 and the user behavior monitoring means 470 may be combined into one common unit or module.

The invention has been described above in detail with reference to embodiments thereof. However, as is readily understood by those skilled in the art, other embodiments are equally possible within the scope of the present invention, as defined by the appended claims.

1. A portable electronic device comprising
a display;
control means for setting of a user interface feature; and
user behavior monitoring means configured to watch for a predefined user behavior pattern and, upon detection of said user behavior pattern, cause said control means to set a corresponding user interface feature.

2. The portable electronic device according to claim 1, wherein said user interface feature is user-configurable.

3. The portable electronic device according to claim 1, wherein said control means is configured to determine that a time period has lapsed since the setting of said user interface feature and then display a prompt on said display and to receive an acceptance of the setting of said user interface feature and to determine whether said acceptance is negative and if so reset said user interface feature.

4. The portable electronic device according to claim 1, wherein said control means is configured to display a prompt on said display informing that the user interface feature has been set.

5. The portable electronic device according to claim 1, wherein said control means is configured to set a corresponding user interface feature by:
presenting on said display an offer to change said user interface feature to a value reflecting said detected user behavior pattern,
accepting a confirmation from the user, and
setting said user interface feature to the offered and accepted value.

6. The portable electronic device according to claim 1, wherein said control means is configured to set a corresponding user interface feature by:
offering on said display a plurality of available setting values of said user interface feature for selection by a user of the portable electronic device,
accepting a selected one of said available setting values, and
setting said user interface feature to said selected setting value.

7. The portable electronic device according to claim 5, further comprising a non-volatile memory, wherein said control means is configured to
store said offered and accepted value in said non-volatile memory,
read, upon power-on or system reset of said portable electronic device, said stored value from said non-volatile memory, and
set said user interface feature to said read value.

8. The portable electronic device according to claim 1, further having a radio transceiver for connection to a mobile telecommunication network, wherein the predefined user behavior pattern involves use of one or more other services in said portable electronic device than voice calls.

9. The portable electronic device according to claim 1, further having a graphical user interface with a plurality of user-configurable settings, wherein the predefined user behavior pattern involves that the user has made one or more changes to said user-configurable settings.

10. The portable electronic device according to claim 1, further having an operating system capable of executing one or more application programs, wherein the predefined user behavior pattern involves downloading, installation or execution of a particular application program or type of application program.

11. The portable electronic device according to claim 10, wherein the predefined user behavior pattern involves a frequency of downloading, installing or executing a particular application program or type of application program.

12. The portable electronic device according to claim 1, further having an operating system capable of executing one or more application programs, wherein the predefined user behavior pattern involves executing a number of applications simultaneously.

13. The portable electronic device of according to claim 1, wherein said predefined user behavior pattern involves a frequency of inputting commands.

14. The portable electronic device of according to claim 1 wherein said user interface feature relates to a threshold delay time and wherein said portable electronic device further comprises a keypad having a plurality of keys, at least some of which have multiple functions, specifically such that when a time lapse between two successive actuations of one and the same particular key is shorter than said threshold delay time, a first action is taken on said display, whereas otherwise a second action is taken on said display.

15. The portable electronic device according to claim 14, said keypad supporting multi-tap text entry for presentation on said display,
wherein said first action is replacing on said display, without cursor advancement, a currently presented character with a subsequent character, both associated with said particular key, and
wherein said second action is keeping said currently presented character on said display and advancing the cursor.

16. The portable electronic device according to claim 14, wherein said keypad is an ITU-T type keyboard.

17. The portable electronic device according to claim 14, wherein said display is a touch-sensitive display screen and said keypad is a virtual keypad presentable on said touch-sensitive display screen.

18. The portable electronic device according to claim 1 wherein said user interface feature relates to a resolution of said display.

19. The portable electronic device according to claim 1 further comprising means for displaying a text in a font on said display and wherein said user interface feature relates to a font size.

20. The portable electronic device according to claim 1 further comprising means for displaying a confirmation dialogue box for an application on said display and wherein said user interface feature relates to whether said confirmation dialogue box should be displayed or not.

21. The portable electronic device according to claim 1 further comprising means for displaying a virtual keypad on said display, wherein said display is a touch-sensitive display screen, said virtual keypad comprising at least one virtual key and wherein said user interface feature relates to a size of a touch area for said at least one virtual key.

22. The portable electronic device according to claim 6, further comprising a non-volatile memory, wherein said control means is configured to
store said selected setting value in said non-volatile memory,
read, upon power-on or system reset of said portable electronic device, said stored selected setting value from said non-volatile memory, and
set said user interface feature to said read value.

23. A portable electronic device comprising
a display;
a keypad having a plurality of keys, at least some of which have multiple functions, specifically such that when a time lapse between two successive actuations of one and the same particular key is shorter than a threshold delay time, a first action is taken on said display, whereas otherwise a second action is taken on said display;
control means for user-configurable setting of said threshold delay time; and
user behavior monitoring means configured to watch for a predefined user behavior pattern and, upon detection of said user behavior pattern, cause said control means to set said threshold delay time to a value reflecting said user behavior pattern.

24. The portable electronic device according to claim 23, further having a radio transceiver for connection to a mobile telecommunication network, wherein the predefined user behavior pattern involves use of one or more other services in said portable electronic device than voice calls.

25. The portable electronic device according to claim 23, further having a graphical user interface with a plurality of user-configurable settings, wherein the predefined user behavior pattern involves that the user has made one or more changes to said user-configurable settings.

26. The portable electronic device according to claim 23, further having an operating system capable of executing one or more application programs, wherein the predefined user behavior pattern involves downloading, installation or execution of a particular application program or type of application program.

27. The portable electronic device according to claim 26, wherein the predefined user behavior pattern involves a frequency of downloading, installing or executing a particular application program or type of application program.

28. The portable electronic device according to claim 23, further having an operating system capable of executing one or more application programs, wherein the predefined user behavior pattern involves executing a number of applications simultaneously.

29. The portable electronic device according to claim 23, wherein said predefined user behavior pattern involves a frequency of inputting commands.

30. The portable electronic device according to claim 23, wherein said control means is configured to set said threshold delay time by:
presenting on said display an offer to change said threshold delay time to said value reflecting said detected user behavior pattern,
accepting a confirmation from a user of the portable electronic device, and
setting said threshold delay time to the offered and accepted value.

31. The portable electronic device according to claim 23, wherein said control means is configured to set said threshold delay time by:
offering on said display a plurality of available setting values of said threshold delay time for selection by a user of the portable electronic device,
accepting a selected one of said available setting values, and
setting said threshold delay time to the selected setting value.

32. The portable electronic device according to claim 30, further comprising a non-volatile memory, wherein said control means is configured to
store said offered and accepted value in said non-volatile memory,
read, upon power-on or system reset of said portable electronic device, said stored value from said non-volatile memory, and
set said threshold delay time to said read value.

33. The portable electronic device according to claim 31, further comprising a non-volatile memory, wherein said control means is configured to
store said selected setting value in said non-volatile memory,
read, upon power-on or system reset of said portable electronic device, said stored selected setting value from said non-volatile memory, and
set said threshold delay time to said read value.

34. The portable electronic device according to claim 23, wherein said control means is configured to determine that a time period has lapsed since the setting of said threshold delay time and then display a prompt on said display and to receive an acceptance of the setting of said threshold delay time and to determine whether said acceptance is negative and if so reset said threshold delay time.

35. The portable electronic device according to claim 23, said keypad supporting multi-tap text entry for presentation on said display,
wherein said first action is replacing on said display, without cursor advancement, a currently presented character with a subsequent character, both associated with said particular key, and
wherein said second action is keeping said currently presented character on said display and advancing the cursor.

36. The portable electronic device according to claim 23, wherein said keypad is an ITU-T type keyboard.

37. The portable electronic device according to claim 23, wherein said display is a touch-sensitive display screen and said keypad is a virtual keypad presentable on said touch-sensitive display screen.
